(19) United States
(12) Patent Application Publication
(10) Pub. No.: US 2005/0239590 A1
(43) Pub. Date: Oct. 27, 2005

(54) Energy absorbing chain guide

(75) Inventor: Jeffrey Foster, Horseheads, NY (US)

Correspondence Address: BORGWARNER INC., 3850 HAMLIN ROAD, AUBURN HILLS, MI, 48326, US

(73) Assignee: BorgWarner Inc., Auburn Hills, MI (US)

(21) Appl. No.: 10/829,722

(22) Filed: Apr. 22, 2004

(51) Int. Cl. F16H 7/08; F16H 7/18; B65G 25/04

(52) U.S. Cl. 474/140; 474/111

(57) ABSTRACT

A curved rod, preferably circular and preferably made of steel, is overmolded with a thermoplastic or elastomeric material to form a chain guide. The ends of the curved rod are modified to add bolt mounting features for the chain guide. The present invention is preferably tuned to a specific stiffness to act as an absorber for the normal force generated from the tension in a guided chain strand. In a preferred embodiment, the overmolding is made of nylon. Preferably, the curved rod has a circular cross-section. In additional embodiments, the curved rod has a square cross-section or a rectangular cross-section. In another embodiment of the present invention, the curved rod has a varying cross-sectional area. In another preferred embodiment, a plurality of plates with different convex surfaces are overmolded to provide a chain guide with varying stiffness.

### BACKGROUND OF THE INVENTION

1. Field of the Invention

The invention pertains to the field of chain guides. More particularly, the invention pertains to a composite chain guide with a metal core and an elastomeric or thermoplastic coating.

2. Description of Related Art

Many chain guide structures are known in the prior art. Typical chain guides for engine timing systems have been made of metals and composite materials such as glass-reinforced polymers. Increasingly, chain guides are made of plastic. The guides support the chains used in engine timing systems to transfer torque and reduce the ratio from the crankshaft sprocket to the camshaft sprockets. It is necessary to maintain chain tension in order to avoid loss of control in the chain strands between the sprockets, but an effective chain guide must have some flexibility to prevent over-constraint of the chain, which could lead to the chain breaking.

There have been a number of composite chain guides and guiding systems patented in the past.

In U.S. Pat. No. 5,266,066, SPRING BLADE CHAIN TENSIONER, issued Nov. 30, 1993 to White, the blade-type chain tensioner is constructed from a plastic shoe and a metal blade spring. The shoe is slightly arcuate and has a pocket along its concave side. At each end of the pocket is a cavity. The blade spring is substantially more arcuate than the shoe and is rectangular. The blade spring is dimensioned to allow each end of the blade spring to be mounted in the pocket with an end in each cavity at the end of a shoe. Through this configuration the blade spring is mechanically interlocked with the shoe without the use of fasteners or cutouts. The blade spring places a load on the shoe, causing the shoe to creep at an elevated temperature and thereby provide tension to a chain. The tensioner is mounted through the plastic shoe, and the blade spring does not have mounting holes.

In U.S. Pat. No. 5,653,652, HYDRAULIC TENSIONING SYSTEM WITH DUAL ARM BLADE, issued Aug. 5, 1997 to Simpson, the chain tensioner system has a dual arm blade and a hydraulic tensioner. The hydraulic tensioner applies force against the free ends of the dual arms. Each arm is supported in two places, at the pivot point and against the tensioner piston. A face material is added to the surface of the arm. The arms are simple flat plastic shoes with a hole at one end for the pivot point. A blade spring can be inserted into one or both of the plastic shoes. The tensioner piston moves in and out, and the arms in the dual arm tensioner system slide against one another. As one of the tensioner arms applies the force to the chain, the other arm damps the movement of the first arm. In some applications extra ribbing and wings are added to increase the strength of the arm. A plastic face material is added to the chain-contacting surface of the arm. The tensioner is mounted through the plastic shoe, and the blade spring does not have mounting holes.

In U.S. Pat. No. 4,932,517, GUIDE RAIL SYSTEM, issued Jun. 12, 1990 to Johnson, a system for guiding articles along a path consists of a rail with a metal core and a sheath of polymer material surrounding it. The sheath is formed to provide a generally cylindrical surface facing toward the path. An opposite surface is adapted to be used in clamping the rail in a selected position. Preferably, the core is formed of stainless steel of circular cross-section and the sheath is formed of high-density polyethylene. The guide rail is mounted by a clamp attached to the external polymer surface.

There is a need in the art for a chain guide that lowers chain tensions and reduces chain vibrations.

### SUMMARY OF THE INVENTION

A curved rod, preferably circular and preferably made of steel, is overmolded with a thermoplastic or elastomeric material to form a chain guide. The ends of the curved rod are modified to add bolt mounting features for the chain guide. The present invention is preferably tuned to a specific stiffness to act as an absorber for the normal force generated from the tension in a guided chain strand. The stiff core maintains the shape of the chain-contacting surface better than plastic or composite prior art chain guides, while the flexible overmolding provides the chain with a cushion to prevent breakage. With a rod-like stiff core anchored in line by mounting bolts and a flexible overmolding for contacting the chain, the chain guide serves to lower chain tensions and reduce chain vibrations. In one embodiment of the present invention, the chain guide has a nonlinear stiffness along its length. The chain guide preferably has a low stiffness at low deflections and a high stiffness at greater deflections. This reduces the low amplitude vibration or chain tension normal forces, allowing the chain guide to handle the larger tension inputs.

The chain guide includes a curved rod made of a first material and includes a first end including a first aperture for mounting the chain guide, a second end including a second aperture for mounting the chain guide, a middle section between the first end and the second end, a convex side, and a concave side. An overmolding made of a second material covers the middle section of the curved rod and forms a chain-contacting surface over the convex side of the curved rod. In one embodiment of the present invention, the middle section tapers from the first and second ends toward the centerline. The first material is preferably steel, titanium, aluminum, or a carbon fiber, but could be any appropriate material. The second material is preferably a thermoplastic or elastomeric material. The second material is more preferably nylon. In one embodiment, the center section of the curved rod has a circular cross-section. In other embodiments, the center section has a square or a rectangular cross-section.

In another embodiment of the present invention, the chain guide includes a plurality of curved plates, each made of a first material and including a first end including a first aperture for mounting the chain guide, a second end including a second aperture for mounting the chain guide, a convex side, and a concave side. An overmolding made of a second material covers the middle sections of the curved plates and forms a chain-contacting surface over the convex side of the curved plates. At least one of the curved plates preferably has the convex side closer to the chain-contacting surface than the convex side of at least one other curved plate. The chain guide preferably includes a center curved plate and two outer curved plates. The first material is preferably steel, titanium, aluminum, or a carbon fiber, but could be any appropriate material. The second material is preferably a thermoplastic or elastomeric material. The second material is more preferably nylon.

### BRIEF DESCRIPTION OF THE DRAWINGS

FIG. 1 shows a side view of an embodiment of the present invention.

FIG. 2 shows a top view of an embodiment of the present invention.

FIG. 3A shows a cross-section of the III-III plane of FIG. 1 and FIG. 2, where the core has a circular cross-section.

FIG. 3B shows a cross-section of the III-III plane of FIG. 1 and FIG. 2, where the core has a square cross-section.

FIG. 3C shows a cross-section of the III-III plane of FIG. 1 and FIG. 2, where the core has a rectangular cross-section.

FIG. 4 shows a side view of another embodiment of the present invention.

FIG. 5 shows a side view of an additional embodiment of the present invention.

FIG. 6 shows a top view of the embodiment of FIG. 5.

### DETAILED DESCRIPTION OF THE INVENTION

In the present invention, a rigid component, such as a curved rod, of the guide is the primary structural member, and it has a hole at each end for a mounting bolt. Preferably, it has a center section with a circular cross-section. The cross-section of the structural member is designed such that the structural member deflects at particular loads that are harmful to the chain drive. The overmolded section acts as a wear surface and guide for the chain as it passes. This material is preferably an elastomer or thermoplastic, such as nylon, with some ductility at engine operating conditions. An elastomer, such as a low durometer rubber, also serves as a good overmolding material. The composite chain guide of the present invention is an inexpensive solution to reducing chain tensions in a chain drive. The structural member provides the necessary constraint, while the overmolded section provides the wear surface and the necessary cushion. The invention also has some noise-vibration harshness (NVH) benefits. By absorbing the chain tensions and vibrations, the chain guide of the present invention reduces the noise energy of the chain system.

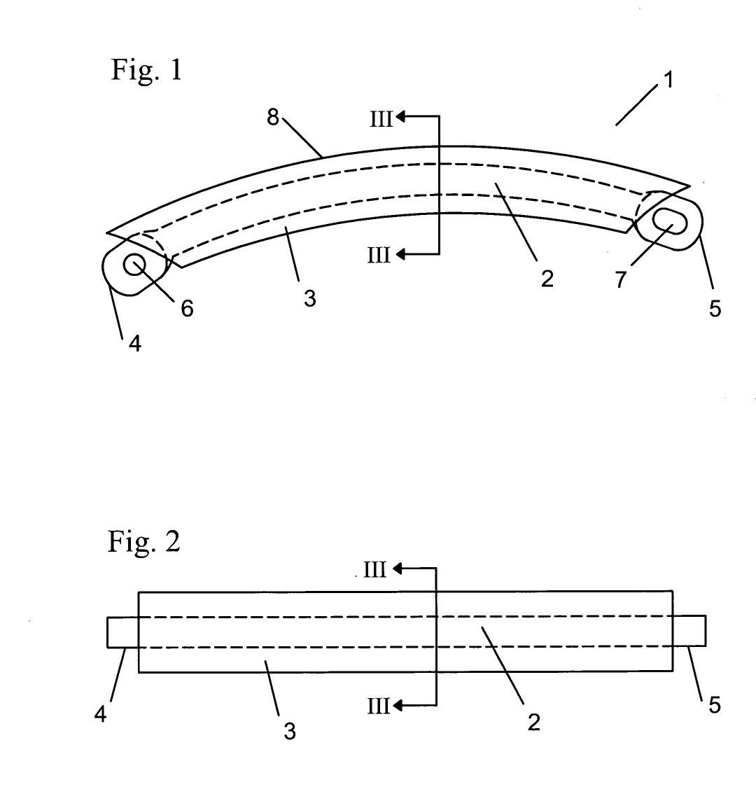

Referring to FIGS. 1 and 2, in one embodiment of the present invention, the energy absorbing chain guide (1) includes a stiff rod (2) overmolded with a flexible material (3). The ends (4) and (5) of the stiff rod (2) are modified to form bolt holes (6) and (7) for receiving bolts for mounting the chain guide (1). The flexible material (3) has a chain contacting surface (8) along the convex side of the chain guide (1). The stiff rod (2) is preferably made of metal and more preferably made of steel. Titanium, aluminum, and carbon fiber are other preferred materials for the rod. The flexible material (3) is preferably an elastomeric or thermoplastic material, including, but not limited to, nylon. FIG. 2 shows a top view of the stiff rod (2) and the flexible overmolding (3). Although FIG. 2 shows the ends (4) and (5) having the same depth as the center section (2) as seen from above, the ends are typically flattened relative to the center section for the formation of the mounting holes.

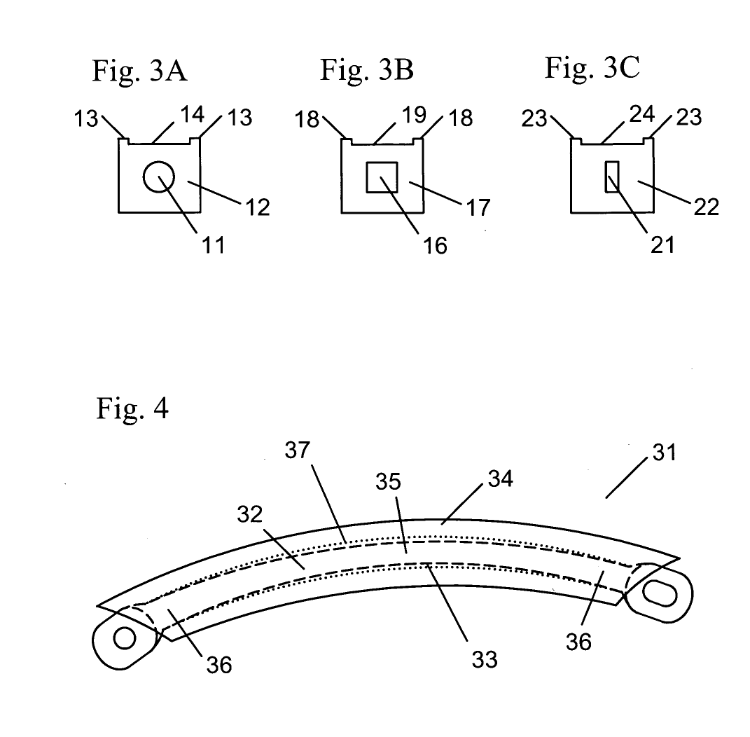

Referring also to FIGS. 3A through 3C, cross-sections of three different embodiments of the present invention are shown along section III-III of FIGS. 1 and 2. In the first embodiment, shown in FIG. 3A, the stiff rod (11) has a circular cross-section. The overmolded flexible material (12) is rectangular in shape preferably with two raised edges (13) to aid in maintaining a chain along the chain-contacting surface (14). In the second embodiment, shown in FIG. 3B, the stiff rod (16) has a square cross-section. The overmolded flexible material (17) is rectangular in shape preferably with two raised edges (18) to aid in maintaining a chain along the chain-contacting surface (19). In the third embodiment, shown in FIG. 3C, the stiff rod (21) has a rectangular cross-section. The overmolded flexible material (22) is rectangular in shape preferably with two raised edges (23) to aid in maintaining a chain along the chain-contacting surface (24). The rectangular stiff rod (21) would appear narrower in a top view than what is shown in FIG. 2.

In another embodiment of the present invention, the resistance to bending is varied along the length of the chain guide. The stiffness preferably varies such that the middle of the chain guide is less stiff than the ends. Additionally, the chain guide preferably has a low stiffness at low deflections and a high stiffness at greater deflections. This reduces the low amplitude vibration or chain tension normal forces, allowing the chain guide to handle the larger tension inputs.

This embodiment is preferably achieved by varying the cross-section of the curved rod along its length or by the use of a plurality of plates. Tapering the center section from the ends toward the center achieves the desired effect. Alternatively, the overmolding contacts a center plate first. Upon sufficient deflection, the center plate contacts two outer plates, significantly increasing the stiffness of the chain guide.

Referring to FIG. 4, an embodiment of the present invention with a varying stiffness along the chain guide length is shown. The chain guide (31) includes a curved rod (32) having a center section profile shown with dashed lines (33) under the overmolding (34). The curved rod has in the middle (35) a minimum cross-sectional area, which increases toward the ends (36). This profile gives the chain guide (31) less stiffness in the middle than toward the ends. The dotted lines (37) show the profile of the center section of a curved rod with a constant cross-sectional area.

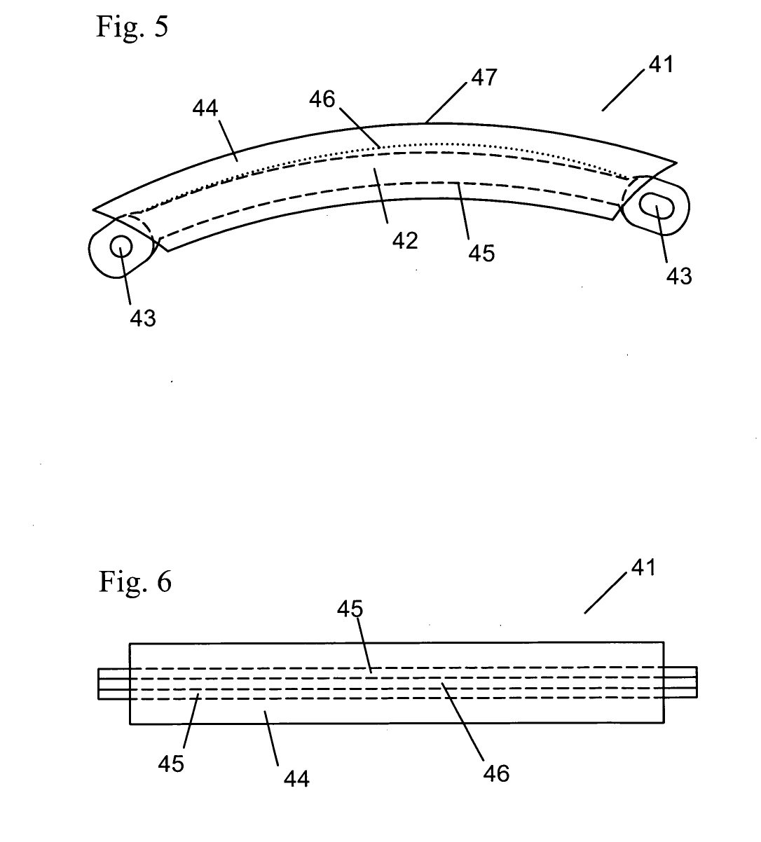

Referring to FIGS. 5 and 6, another embodiment of the present invention with a varying stiffness along the chain guide length is shown. The chain guide (41) includes three curved plates (42), with a mounting hole (43) on each end and stacked adjacent to each other, and an overmolding (44). The curved plates are preferably made of steel, titanium, aluminum, or a carbon fiber, but can be composed of any appropriate material. The overmolding is preferably an elastomer or thermoplastic such as nylon. From the side, FIG. 5 shows the center section profile (45) of the two outer plates with dashed lines. Sandwiched between the two outer plates is a center plate, with a profile that deviates from the two outer plates on the convex side as shown by the dotted line (46). The two outer plates (45) and the inner plate (46) are visible in the top view of FIG. 6.

Under the load of a chain on the chain contacting surface (47), the center curved plate alone provides stiffness, until it is deflected to have its convex surface aligned with the two outer plates. At this point, all three plates provide resistance, effectively tripling the stiffness of the chain guide. This allows the chain guide to be less stiff under small loads and stiffer under larger loads. Additionally, the chain guide is stiffer toward the ends than in the middle. Greater control of the stiffness of the chain guide is achieved with additional plates having additional at-rest convex surface positions.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A chain guide comprising:
a curved rod made of a first material and comprising a first end including a first aperture for mounting the chain guide, a second end including a second aperture for mounting the chain guide, a middle section between the first end and the second end, a convex side, and a concave side; and
an overmolding made of a second material and covering the middle section of the curved rod and forming a chain-contacting surface over the convex side of the curved rod.

2. The chain guide of claim 1, wherein the middle section further comprises a centerline and the middle section tapers from the first and second ends toward the centerline.

3. The chain guide of claim 1, wherein the first material is selected from the group consisting of titanium; aluminum; and a carbon fiber.

4. The chain guide of claim 1, wherein the first material is steel.

5. The chain guide of claim 1, wherein the second material is nylon.

6. The chain guide of claim 1, wherein the second material is a thermoplastic.

7. The chain guide of claim 1, wherein the second material is an elastomer.

8. The chain guide of claim 1, wherein the middle section of the curved rod has a circular cross-section.

9. The chain guide of claim 1, wherein the middle section of the curved rod has a square cross-section.

10. The chain guide of claim 1, wherein the middle section of the curved rod has a rectangular cross-section.

11. The chain guide of claim 1, wherein the middle section of the curved rod has a varying cross-section.

12. A chain guide comprising:
a plurality of curved plates, each made of a first material and comprising a first end including a first aperture for mounting the chain guide, a second end including a second aperture for mounting the chain guide, a middle section between the first end and the second end, a convex side, and a concave side; and
an overmolding made of a second material and covering the middle sections of the curved plates and forming a chain-contacting surface over the convex side over the curved plates, wherein the curved plates include at least one curved plate having the convex side closer to the chain-contacting surface than the convex side of at least one other curved plate.

13. The chain guide of claim 10, wherein the chain guide includes a center curved plate and two outer curved plates.

14. The chain guide of claim 10, wherein the first material is selected from the group consisting of titanium; aluminum; and a carbon fiber.

15. The chain guide of claim 10, wherein the first material is steel.

16. The chain guide of claim 10, wherein the second material is nylon.

17. The chain guide of claim 10, wherein the second material is a thermoplastic.

18. The chain guide of claim 10, wherein the second material is an elastomer.

19. A chain guide comprising:
a rigid structural component made of a first material and comprising a first end including a first aperture for mounting the chain guide, a second end including a second aperture for mounting the chain guide, a middle section between the first end and the second end, a convex side, and a concave side; and
an overmolding made of a second material and covering the middle section of the rigid structural component and forming a chain-contacting surface over the convex side of the rigid structural component;
wherein a stiffness of the chain guide varies along a length of the chain guide.

20. The chain guide of claim 19, wherein the middle section of the rigid structural component is less stiff than the ends of the rigid structural component.
